(19) United States
(12) Patent Application Publication
(10) Pub. No.: US 2024/0128478 A1
(43) Pub. Date: Apr. 18, 2024

(54) LITHIUM PRIMARY BATTERY AND NONAQUEOUS ELECTROLYTE SOLUTION USED IN SAME

(71) Applicant: Panasonic Intellectual Property Management Co., Ltd., Kadoma-shi, Osaka (JP)

(72) Inventor: Satoshi Nishitani, Osaka Fu (JP)

(73) Assignee: Panasonic Intellectual Property Management Co., Ltd., Kadoma-shi, Osaka (JP)

(21) Appl. No.: 18/277,148

(22) PCT Filed: Aug. 3, 2021
(86) PCT No.: PCT/JP2021/028709

§ 371 Date: Aug. 14, 2023

(30) Foreign Application Priority Data
Feb. 18, 2021 (JP) 2021-023951

(51) Int. Cl. H01M 6/16

(52) U.S. Cl. CPC H01M 6/168; H01M 2300/0025

(57) ABSTRACT

A lithium primary battery includes a positive electrode, a negative electrode, and a non-aqueous electrolyte, wherein the positive electrode includes a positive electrode mixture including manganese dioxide, the negative electrode includes at least one of a metal lithium and a lithium alloy, the non-aqueous electrolyte includes an isocyanate compound as a first component, and at least one of a cyclic imide compound and a phthalic acid ester compound as a second component, the non-aqueous electrolyte has an isocyanate compound concentration of 5 mass % or less.

### TECHNICAL FIELD

The present disclosure relates to a lithium primary battery and a non-aqueous electrolyte used therefor.

### BACKGROUND ART

Lithium primary batteries have a high energy density, and with less self-discharge, they are suitable for a long-time use. As a power source for a device used for a long time, use of a lithium primary battery has been increasing. For example, a smart meter is a device that sends data relating to amounts of used gas or electricity, and is required to operate continuously without maintenance for a long period of time. During usage, the lithium primary battery is required to maintain a high internal electromotive force and a low internal resistance.

Patent Literature 1 proposes a non-aqueous organic electrolyte for a lithium primary battery, including a positive electrode including a positive electrode material with manganese dioxide as a positive electrode active material and a current collector composed of stainless steel, a negative electrode composed of a lithium metal or a lithium alloy, wherein LiCF₃SO₃ is included as a supporting salt, and LiB(C₂O₄)₂ is added.

Patent Literature 2 proposes a non-aqueous electrolyte battery having a negative electrode composed of metal lithium, a lithium alloy, or a material capable of storing and releasing lithium, a positive electrode, and a non-aqueous electrolyte composed of a solvent and a solute dissolved in the solvent, wherein the non-aqueous electrolyte includes a cyclic imide compound.

Patent Literature 3 proposes a non-aqueous electrolyte battery including a negative electrode composed of lithium, a lithium alloy, or a carbon material capable of electrochemically storing and releasing lithium, a positive electrode with manganese dioxide as an active material, and a non-aqueous electrolyte containing a low boiling point solvent, wherein phthalic acid diester is added to the non-aqueous electrolyte as an additive.

### CITATION LIST

### Patent Literature

PLT1: Japanese Laid-Open Patent Publication No. 2015-022985
PLT2: WO2001/041247
PLT3: Japanese Laid-Open Patent Publication No. H07-22069

### SUMMARY OF INVENTION

For the lithium primary battery to keep a high internal electromotive force, it is necessary to protect the positive electrode and the negative electrode with a coating to suppress side reactions or self-discharge. Thus, as proposed by the above-described Patent Literatures, inclusion of an additive having protection functions to the non-aqueous electrolyte has been examined. However, use of such an additive may increase the internal resistance or decrease the internal electromotive force.

An aspect of the present disclosure relates to a lithium primary battery including a positive electrode, a negative electrode, and a non-aqueous electrolyte, wherein the positive electrode includes a positive electrode mixture including manganese dioxide, the negative electrode includes at least one of a metal lithium and a lithium alloy, the non-aqueous electrolyte includes an isocyanate compound as a first component, and at least one of a cyclic imide compound and a phthalic acid ester compound as a second component, and the non-aqueous electrolyte has an isocyanate compound concentration of 5 mass % or less.

Another aspect of the present disclosure relates to a non-aqueous electrolyte used for a lithium primary battery, the lithium primary battery including a positive electrode including a positive electrode mixture including manganese dioxide, a negative electrode including at least one of a metal lithium and a lithium alloy, and a non-aqueous electrolyte, wherein the non-aqueous electrolyte includes an isocyanate compound as a first component, at least one of a cyclic imide compound and a phthalic acid ester compound as a second component, and the non-aqueous electrolyte has an isocyanate compound concentration of 5 mass % or less.

A lithium primary battery that exhibits a high internal electromotive force and a low internal resistance in an initial period and after high temperature storage can be obtained.

### BRIEF DESCRIPTION OF DRAWINGS

FIG. 1 is a front view, partially shown in cross section, of a lithium primary battery in an embodiment of the present disclosure.

### DESCRIPTION OF EMBODIMENTS

A lithium primary battery of the present disclosure includes a positive electrode, a negative electrode, and a non-aqueous electrolyte. The positive electrode includes a positive electrode mixture including manganese dioxide (e.g., manganese oxide represented by LixMnO₂(0≤x≤0.05)). The negative electrode includes at least one of a metal lithium and a lithium alloy. The non-aqueous electrolyte includes an isocyanate compound as a first component, and at least one of a cyclic imide compound and a phthalic acid ester compound as a second component.

The second component is considered to have effects of suppressing an increase in the internal resistance after the lithium primary battery is stored at a high temperature. The second component forms a stable coating having a lithium ion conductivity on a surface of the negative electrode. In this manner, a surface of the active negative electrode is protected, and excessive coating formation on the negative electrode surface due to side reactions is avoided. However, the effects are insufficient, and the internal resistance in an initial period increases significantly, and the internal resistance after high temperature storage also increases significantly. Also, the second component tends to reduce the initial electromotive force and accelerate self-discharge of lithium primary batteries. These phenomena occur along with side reactions of the second component in the positive electrode, and seem to proceed along with dissolution of Mn from the positive electrode active material.

Meanwhile, when the non-aqueous electrolyte includes the first component and the second component, reduction in the initial electromotive force and the self-discharge in the lithium primary battery are significantly suppressed. Furthermore, increase in the internal resistance after storage at a high temperature is significantly suppressed. This is probably because a composite coating derived from both of the first component and the second component is formed at the surface of manganese dioxide included in the positive electrode. The composite coating is considered to suppress side reactions of the second component in the positive electrode, and suppress reduction in the initial electromotive force and proceeding of self-discharge in the positive electrode.

When using only the first component without using the second component, the internal electromotive force in the initial period and the after storage at a high temperature of the lithium primary battery reduces more, and the increase in the internal resistance after storage at a high temperature becomes significant. This is probably because the composite coating including a component derived from the second component is not formed in the positive electrode, and side reactions involving decomposition of the first component excessively proceed. That is, side reactions of the first component in the positive electrode are particularly suppressed when the second component coexists. Also, when the second component coexists with the first component, side reactions of the second component in the positive electrode are also suppressed. In this manner, reduction in the initial electromotive force and proceeding of self-discharge are greatly mitigated.

In the non-aqueous electrolyte, the isocyanate compound concentration is limited to 5 mass % or less. When the isocyanate compound concentration in the non-aqueous electrolyte exceeds 5 mass %, suppressing side reactions involved with the isocyanate compound becomes difficult. Thus, after storage at a high temperature, the electromotive force greatly reduces, and the internal resistance increases. The isocyanate compound concentration in the non-aqueous electrolyte may be 4 mass % or less, 3 mass % or less, or 2 mass % or less. Furthermore, in view of suppressing reduction in the initial electromotive force and proceeding of self-discharge even more significantly, the isocyanate compound concentration in the non-aqueous electrolyte may be, for example, 0.01 mass % or more, 0.1 mass % or more, or 0.5 mass % or more. When the range is to be limited, these upper and lower limits can be used in any combination.

When a better composite coating is to be formed, the mass ratio of the first component relative to the second component included in the non-aqueous electrolyte is preferably set to 1/3 or more and 50 or less, and it may be 1/2 or more and 10 or less, 1/2 or more and 7 or less, or 1 or more and 5 or less. In this manner, balance of the composition of the composite coating improves, and the effects of suppressing reduction in the initial electromotive force and self-discharge can be apparent even more.

The second component concentration in the non-aqueous electrolyte is, for example, 3 mass % or less, 1.5 mass % or less, or 1 mass % or less. The second component concentration in the non-aqueous electrolyte is, for example, 0.01 mass % or more, and may be 0.1 mass % or more, or 0.3 mass % or more. When the range is to be limited, these upper and lower limits can be used in any combination.

The first component and second component concentrations (mass %) may be within the above-described range in the non-aqueous electrolyte included in a battery in an initial period after use or in the electrolyte before injected into the battery. After the start of use, the first component and second component concentrations in the non-aqueous electrolyte may change in the lithium primary battery used for a considerable time period. Therefore, it is sufficient that the first component and the second component remain at a concentration equal to or higher than the detection limit in the non-aqueous electrolyte taken out from such a lithium primary battery. In the non-aqueous electrolyte taken out from a battery other than the battery after use and in an initial period, the first component content may be, for example, 0.0001 mass % or more, and the second component content may be, for example, 0.0001 mass % or more. In this case as well, the mass ratio of the first component relative to the second component reflects the initial mass ratio, and it can fall within the range of 1/3 or more and 50 or less.

Of the examples of the second component, the cyclic imide compound is more preferable. The cyclic imide compound content in the second component may be 50 mass % or more, 70 mass % or more, or 90 mass % or more.

### (Isocyanate Compound)

The isocyanate compound has, for example, at least one isocyanate group and a C1 to C20 aliphatic hydrocarbon group or a C6 to C20 aromatic hydrocarbon group. The aliphatic hydrocarbon group and the aromatic hydrocarbon group composing the isocyanate compound may have a substituent. The substituent may be a group that can be present stably, and for example, it may be a halogen atom, or a nitrile group. The aliphatic group may be an alicyclic aliphatic group, a straight chain, or a branched chain aliphatic group. The aromatic hydrocarbon group is a hydrocarbon group having one or more aromatic rings, or may be a group in which an aromatic ring and an aliphatic group are bonded.

The isocyanate compound may be a monoisocyanate compound having one isocyanate group, a diisocyanate compound having two isocyanate groups, or a polyisocyanate compound having three or more isocyanate groups. The isocyanate compound may have the isocyanate group of five or less, or four or less. It is considered that the diisocyanate compound forms a composite coating with a lower resistance than that of the monoisocyanate compound, and forms a homogeneous composite coating than triisocyanate. Also, the diisocyanate compound is highly capable of forming a composite coating with a small amount, and is excellent in stability in the battery.

Specific examples of the isocyanate compound include methyl isocyanate, ethyl isocyanate, propyl isocyanate, butyl isocyanate, pentyl isocyanate, hexyl isocyanate, heptyl isocyanate, octyl isocyanate, cyclohexane isocyanate, phenyl isocyanate, fluorophenyl isocyanate, methoxy carbonyl isocyanate, tetramethylene diisocyanate, pentamethylene diisocyanate, hexamethylene diisocyanate, heptamethylene diisocyanate, octamethylene diisocyanate, 1,2-bis(isocyanatomethyl)cyclohexane, 1,3-bis(isocyanatomethyl)cyclohexane, 1,4-bis(isocyanatomethyl)cyclohexane, 1,2-bis(isocyanatoethyl)cyclohexane, 1,3-bis(isocyanatoethyl)cyclohexane, 1,4-bis(isocyanatoethyl)cyclohexane, isophorone diisocyanate, 2,4-tolylene diisocyanate, 2,6-tolylene diisocyanate, xylylene diisocyanate, phenyl diisocyanate, toluene diisocyanate, diisocyanato naphthalene, o-tolidine diisocyanate, lysine diisocyanate, dicyclohexyl methane-4,4′-diisocyanate, bis(4-isocyanato phenyl) methane, 1,6,11-triisocyanato undecane, 1,3,5-tris(6-isocyanato hexa-1-yl)-1,3,5-triazine-2,4,6(1H,3H,5H)-trione, 1,3,5-tris(6-isocyanato tetra-1-yl)-1,3,5-triazine-2,4,6(1H,3H,5H)-trione, 1,3,5-tris(6-isocyanato penta-1-yl)-1,3,5-triazine-2,4,6(1H,3H,5H)-trione, 1,3,5-tris(6-isocyanato tetra-1-yl)-1,3,5-triazine-2,4,6(1H,3H,5H)-trione, and 1,3,5-tris(6-isocyanato hepta-1-yl)-1,3,5-triazine-2,4,6(1H,3H,5H)-trione. These may be used singly, or two or more kinds may be used in combination.

In particular, a compound represented by OCN—CₙH₂ₙ—NCO (n is an integer of 1 to 10) (e.g., hexamethylene diisocyanate), a compound having an alicyclic diyl group (e.g., 1,3-bis(isocyanatomethyl)cyclohexane, dicyclohexyl methane-4,4′-diisocyanate, bicyclo [2.2.1]heptane-2,5-diylbis(methyl isocyanate), bicyclo [2.2.1]heptane-2,6-diylbis(methyl isocyanate), isophorone diisocyanate), 2,2,4-trimethyl hexamethylene diisocyanate, 2,4,4-trimethyl hexamethylene diisocyanate, and hexyl isocyanate are easily obtainable. Among these, at least one selected from the group consisting of hexyl isocyanate, hexamethylene diisocyanate, 1,3-bis(isocyanatomethyl)cyclohexane, and isophorone diisocyanate is preferable, and these may be 50 mass % or more, even 70 mass % or more, or 90 mass % or more of the isocyanate compound.

### (Cyclic Imide Compound)

The cyclic imide compound having a diacylamine ring (imide ring) will suffice. Another ring (second ring) may be condensed with the imide ring. The second ring may be an aromatic ring, or a saturated or unsaturated aliphatic ring. At least one hetero atom may be included in the second ring. Examples of the hetero atom include an oxygen atom, a sulfur atom, and a nitrogen atom. The non-aqueous electrolyte may include one type of cyclic imide compound, or two or more types.

The cyclic imide compound may be included in the non-aqueous electrolyte in a state of imide having a free NH group, in a form of tertiary amine, or a form of an anion or a salt. Even when the cyclic imide compound is included in a form of tertiary amine, anion, or salt, in this specification, the first component concentration in the non-aqueous electrolyte is a value calculated as the concentration of the first component having a free NH group.

The cyclic imide compound may be a N-substituted imide compound having a substituent at the nitrogen atom of imide. Examples of such a substituent include a hydroxy group, an alkyl group, an alkoxy group, and a halogen atom. The alkyl group may be, for example, a C1 to C4 alkyl group, a methyl group, and an ethyl group. The alkoxy group may be, for example, a C1 to C4 alkoxy group, a methoxy group, and an ethoxy group. The halogen atom is, for example, a chlorine atom, a fluorine atom, or the like.

The cyclic imide compound may be a hydrogenated product, for example, a hydrogenated product of phthalimide.

Specific examples of the cyclic imide compound include phthalimide, hexahydro phthalimide, N-methyl phthalimide, N-hydroxy phthalimide, N-hydroxy methyl phthalimide, N-(2-hydroxy ethyl) phthalimide, N-fluoro phthalimide, N-(phenyl thio)phthalimide, N-(cyclohexyl thio)phthalimide, N-(propane thio)butfluoro phthalimide, succinimide, N-hydroxy succinimide, N-fluoro succinimide, cyclohexa-3-en-1,2-dicarboximide, cyclohexane-1,2-dicarboximide, and N-(phenyl thio)imide. These may be used singly, or two or more kinds may be used in combination. Preferably, in particular, at least one selected from the group consisting of phthalimide, hexahydro phthalimide, N-methyl phthalimide, N-hydroxy phthalimide, N-hydroxy methyl phthalimide, N-(2-hydroxy ethyl) phthalimide, N-fluoro phthalimide, succinimide, N-hydroxy succinimide, and N-fluoro succinimide is used.

Preferably, the cyclic imide compound is at least one selected from the group consisting of phthalimide and N-substituted phthalimide. These compounds may be 50 mass % or more, or even 70 mass % or more, or 90 mass % or more of the cyclic imide compound. Preferably, the cyclic imide compound may include at least phthalimide. The phthalimide may be 50 mass % or more, or even 70 mass % or more, or 90 mass % or more of the cyclic imide compound.

### (Phthalic Acid Ester Compound)

The phthalic acid ester compound includes phthalic acid ester and derivatives thereof. The derivative may have a substituent bonded to an aromatic ring derived from phthalic acid. Examples of the substituent include a hydroxy group, an alkyl group, an alkoxy group, and a halogen atom. Examples of the alkyl group include a C1 to C4 alkyl group, and may be a methyl group, or an ethyl group. Examples of the alkoxy group include a C1 to C4 alkoxy group, and it may be a methoxy group, or an ethoxy group. The halogen atom is, for example, a chlorine atom, a fluorine atom, or the like.

The phthalic acid ester compound may be a monoester, but preferably is diester. For the alcohol that forms ester with the phthalic acid (or a derivative thereof), a C1 to C20 (preferably C1 to C6) saturated or unsaturated aliphatic alcohol is preferably used.

Specific examples of the phthalic acid ester compound include dimethyl phthalate, diethyl phthalate, diallyl phthalate, dibutyl phthalate, diisobutyl phthalate, and bis(2-ethyl hexyl) phthalate. These may be used singly, or two or more kinds may be used in combination. These may be 50 mass % or more, or even 70 mass % or more, or 90 mass % or more of the phthalic acid ester compound.

For analysis of the non-aqueous electrolyte (first component and second component), for example, liquid chromatography-mass spectrometry (LC/MS) may be used, or along with mass spectrometry (MS), ultraviolet spectroscopy (UV) may be performed.

The lithium primary battery of the present disclosure will be specifically described below.

### [Lithium Primary Battery]

### (Positive Electrode)

The positive electrode includes a positive electrode mixture. The positive electrode mixture includes a positive electrode active material. The positive electrode active material includes manganese dioxide. The positive electrode including manganese dioxide as the positive electrode active material exhibits a relatively high voltage, and has excellent pulse discharge characteristics. Manganese dioxide may be in a state of mixed crystal including a plurality of types of crystal state. The positive electrode may include manganese oxide other than manganese dioxide. Examples of the manganese oxide other than manganese dioxide include MnO, Mn₃O₄, Mn₂O₃, and Mn₂O₇. When the manganese oxide included in the positive electrode includes manganese dioxide as the main component (e.g., 50 mass % or more), it will suffice.

A portion of the manganese dioxide included in the positive electrode may be doped with lithium. When the amount of doped lithium is small, a high capacity can be ensured. Manganese dioxide, and manganese dioxide to which a small amount of lithium is doped can be represented by LixMnO₂ (0≤x≤0.05). The composition of manganese oxide included in the positive electrode being LixMnO₂ (0≤x≤0.05) on average will suffice. The ratio x of Li may be 0.05 or less in a lithium primary battery in a state of initial period of discharge. The ratio x of Li increases as discharging of the lithium primary battery proceeds. The oxidation number of manganese included in manganese dioxide is theoretically four, but on average, the oxidation number of the manganese can be slightly higher or smaller than four.

The positive electrode may include, in addition to manganese dioxide, other positive electrode active materials used in lithium primary batteries. Examples of the other positive electrode active materials include graphite fluoride. However, the ratio of manganese dioxide is preferably 90 mass % or more of the positive electrode active material as a whole.

The manganese dioxide may have a BET specific surface area of, for example, 10 m²/g or more and 40 m²/g or less. When the manganese dioxide has a BET specific surface area in such a range, the effects of suppressing self-discharge can be achieved greatly in lithium primary batteries. Also, the positive electrode mixture layer can be formed easily.

The BET specific surface area of the manganese dioxide can be measured by a known method; for example, a specific surface area measurement device (e.g., manufactured by MOUNTECH Co., Ltd.) is used, and measured based on the BET method. For example, manganese dioxide separated from the positive electrode taken out from a battery can be used as a measurement sample.

The median of the particle size of manganese dioxide may be 10 μm or more and 40 μm or less. When the median of the particle size is in such a range, the effects of suppressing self-discharge are even more improved, and excellent current collecting can be ensured easily in the positive electrode in lithium primary batteries. The median of the particle size of manganese dioxide is a median in a volume-based particle size distribution determined by, for example, a quantitative laser diffraction/scattering method (qLD method). For example, LixMnO₂ separated from the positive electrode taken out from a battery can be used as a measurement sample. For the measurement, for example, SALD-7500 nano manufactured by SHIMADZU CORPORATION is used.

The positive electrode mixture may include a binder, a conductive agent, and the like in addition to the positive electrode active material. Examples of the binder include fluorine resin, rubber particles, and acrylic resin.

Examples of the conductive agent include an electrically conductive carbon material. Examples of the electrically conductive carbon material include natural graphite, artificial graphite, carbon black, and carbon fiber.

The positive electrode may further include a positive electrode current collector that supports the positive electrode mixture. As the material of the positive electrode current collector, for example, stainless steel, aluminum, and titanium can be used.

In the case of a coin-type battery, the positive electrode may be composed of a ring positive electrode current collector having an L-shape cross section attached to positive electrode mixture pellets, or may be composed only of positive electrode mixture pellets. The positive electrode mixture pellets are produced by, for example, adding a suitable amount of water to the positive electrode active material and additive to prepare a positive electrode mixture in a wet state, compression molding the positive electrode mixture, and drying.

In the case of a cylindrical battery, a positive electrode including a sheet positive electrode current collector, and a positive electrode mixture layer supported on the positive electrode current collector can be used. The sheet positive electrode current collector is preferably a porous current collector. Examples of the porous current collector include expanded metal, net, and punched metal. The positive electrode mixture layer is produced by, for example, applying the above-described positive electrode mixture in a wet state to a surface of a sheet positive electrode current collector, or charging the above-described positive electrode mixture to the positive electrode current collector, applying a pressure in a thickness direction, and drying.

### (Negative Electrode)

The negative electrode may include a metal lithium or a lithium alloy, or both of the metal lithium and the lithium metal. A composite of the metal lithium and the lithium alloy may be used as well.

Examples of the lithium alloy include a Li—Al alloy, a Li—Sn alloy, a Li—Ni—Si alloy, a Li—Pb alloy, a Li—Mg alloy, a Li—Zn alloy, a Li—In alloy, and a Li—Al—Mg alloy. In view of ensuring the discharge capacity and stabilizing the internal resistance, the lithium alloy contains a metal element other than lithium in an amount of, preferably, 0.05 to 15 mass %.

The metal lithium, the lithium alloy, or a composite thereof is formed to have any shape and any thickness in accordance with shapes, size, standard, performance, and the like of the lithium primary batteries.

In the case of a coin shape battery, a hoop metal lithium, lithium alloy, and the like may be punched out into a disk to be used as the negative electrode. In the case of a cylindrical battery, a sheet of metal lithium, lithium alloy, and the like may be used as the negative electrode. The sheet may be produced by, for example, extrusion molding.

### (Non-Aqueous Electrolyte)

The non-aqueous electrolyte includes a first component (isocyanate compound) and a second component (at least one of a cyclic imide compound and a phthalic acid ester compound), a non-aqueous solvent, and a lithium salt, or a lithium ion. At least one of the first component and second component may be a lithium salt, or may be capable of generating lithium ions.

### (Non-Aqueous Solvent)

Examples of the non-aqueous solvent include ether, ester, and carbonate. More specifically, dimethyl ether, γ-butyl lactone, propylene carbonate, ethylene carbonate, 1,2-dimethoxyethane, and the like can be used. The non-aqueous solvent may be used singly, or two or more kinds thereof may be used in combination.

In view of improving discharge characteristics of the lithium primary battery, the non-aqueous solvent preferably includes a cyclic carbonate with a high boiling point, and a chain ether having a low viscosity under a low temperature. Preferably, cyclic carbonate includes at least one selected from the group consisting of propylene carbonate (PC) and ethylene carbonate (EC), and particularly preferably PC. Chain ether preferably includes, for example, dimethoxyethane (DME).

### (Lithium Salt)

Examples of the lithium salt include LiCF₃SO₃, LiClO₄, LiBF₄, LiPF₆, LiRaSO₃ (Ra is a C1 to C4 fluoroalkyl group), LiFSO₃, LiN(SO₂Rb) (SO₂Rc) (Rb and Rc are each independently a C1 to C4 fluoroalkyl group), LiN(FSO₂)₂, LiPO₂F₂, LiB(C₂O₄)₂, and LiBF₂(C₂O₄). The non-aqueous electrolyte may include one of these lithium salts, or two or more of these lithium salts.

### (Others)

The non-aqueous electrolyte has a lithium salt (or lithium ion) concentration of, for example, 0.2 to 2.0 mol/L, and it may be 0.3 to 1.5 mol/L.

The non-aqueous electrolyte may include, as necessary, an additive. Examples of the additive include propane sultone and vinylene carbonate. The non-aqueous electrolyte includes such an additive in a total concentration of, for example, 0.003 to 5 mol/L.

### (Separator)

A lithium primary battery generally includes a separator interposed between the positive electrode and the negative electrode. Examples of the separator include, for example, nonwoven fabric, microporous film, or a laminate of these. The separator has a thickness of, for example, 5 μm or more and 100 μm or less.

The nonwoven fabric is composed of, for example, fiber including polypropylene, polyphenylene sulfide, polybutylene terephthalate, and the like. The microporous film includes, for example, polyolefin resin such as polyethylene, polypropylene, ethylene-propylene copolymer, and the like.

The structure of the lithium primary battery is not particularly limited. The lithium primary battery may be a coin-type battery composed of a disk positive electrode and a disk negative electrode laminated with a separator interposed therebetween. The lithium primary battery may be a cylindrical battery including an electrode group composed of a strip positive electrode and a strip negative electrode wound into a swirl with a separator interposed therebetween.

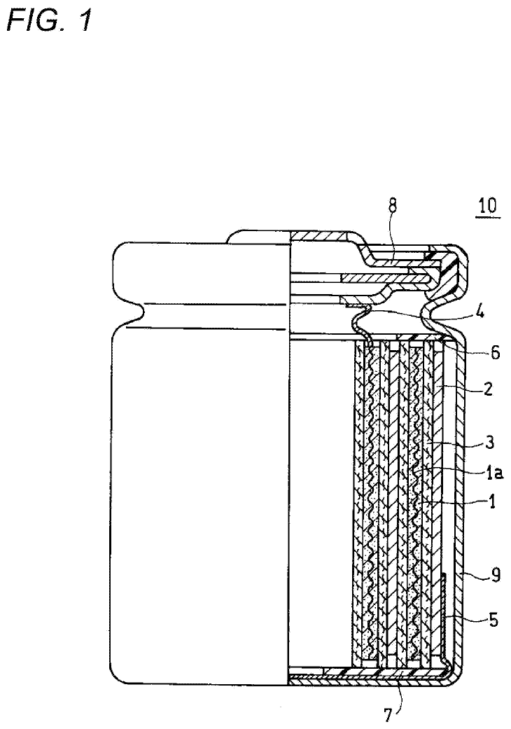

FIG. 1 shows a front view, partially shown in cross section, of a cylindrical lithium primary battery in one embodiment. In a lithium primary battery 10, an electrode group is accommodated in a battery case 9 along with a non-aqueous electrolyte (not shown), the electrode group including a positive electrode 1, a negative electrode 2 wound with a separator 3 interposed therebetween. A sealing plate 8 is attached to an opening of the battery case 9. To the sealing plate 8, a positive electrode lead 4 connected to a current collector 1 a of the positive electrode 1 is connected. A negative electrode lead 5 connected to the negative electrode 2 is connected to the case 9. At an upper portion and a lower portion of the electrode group, an upper insulating plate 6 and a lower insulating plate 7 are disposed, respectively.

### EXAMPLES

The present invention will be described in detail below with reference to Examples and Comparative Examples. The present invention, however, is not limited to the following Examples.

### Examples 1 to 8 and Comparative Examples 1 to 5

### (Positive Electrode Production)

As a positive electrode, to 100 parts by mass of electrolytic manganese dioxide, 5 parts by mass of Ketjen Black as a conductive agent, 5 parts by mass of polytetrafluoroethylene as a binder, and a suitable amount of pure water were added, and the mixture was kneaded, thereby preparing a wet state positive electrode mixture. The median of the particle size of the electrolytic manganese dioxide was within the range of 25 μm to 27 μm, and the BET specific surface area was within the range of 15 to 20 m²/g.

Next, the positive electrode mixture was charged into a stainless steel (SUS444) made positive electrode current collector in a form of an expanded metal with a thickness of 0.1 mm, thereby producing a positive electrode precursor. Afterwards, the positive electrode precursor was dried, rolled with a roll press until the thickness became 0.4 mm, and cut into a sheet with a vertical length of 3.5 cm and a horizontal length of 20 cm, thereby producing a positive electrode. Then, a portion of the charged positive electrode mixture was removed to expose the positive electrode current collector to resistance weld a SUS444 made lead.

### (Negative Electrode Production)

A metal lithium foil with a thickness of 300 μm was cut into a size of a vertical length of 3.7 cm and a horizontal length of 22 cm, thereby producing a negative electrode. A nickel-made lead was connected by welding to a predetermined position of the negative electrode.

### (Electrode Group Production)

The positive electrode and the negative electrode were wound so that they faced each other with the separator interposed therebetween, thereby producing an electrode group. For the separator, a polypropylene-made microporous film with a thickness of 25 μm was used.

### (Non-Aqueous Electrolyte Preparation)

PC, EC, and DME were mixed at a volume ratio of 4:2:4. To the solvent mixture, LiCF₃SO₃ was dissolved to give a concentration of 0.5 mol/L, and a first component and a second component shown in Table 1 were dissolved to give the component concentrations shown in Table 1, thereby preparing a non-aqueous electrolyte.

### (Lithium Primary Battery Assembly)

The electrode group was accommodated in a cylindrical battery case also serving as a negative electrode terminal. An iron-made case (external diameter 17 mm, height 45.5 mm) was used for the battery case. Next, a non-aqueous electrolyte was injected into the battery case, and then the opening of the battery case was closed using a sealing body made of metal serving also as a positive electrode terminal. The other end of the positive electrode lead was connected to the sealing body, and the other end of the negative lead was connected to the inner bottom surface of the battery case. In this manner, a test lithium primary battery was produced. The lithium primary battery had a designed capacity of 2000 mAh. In Table 1, A1 to A8 are batteries of Examples 1 to 8, and B1 to B5 are batteries of Comparative Examples 1 to 5.

The batteries A1 to A8 and batteries B1 to B5 were subjected to measurements of an open circuit voltage (OCV) and an internal resistance (IR) immediately after assembly (initial period) and after storage at a high temperature. The IR was determined by measuring the alternating-current resistance value (ACR) under a 25° C. environment by a two-terminal method. The measurement frequency for the alternating electric current was set to 1 kHz. The OCV and IR after storage at a high temperature were measured after storing the batteries at 70° C. for 100 days. Table 2 shows the results.

TABLE 1

| | First component | | Second component | |
|---|---|---|---|---|
| | | Concentration | | Concentration |
| | Type | (mass %) | Type | (mass %) |
| A1 | Hexamethylene diisocyanate | 1 | Phthalimide | 0.5 |
| A2 | 1,3-bis(isocyanatomethyl) | 1 | Phthalimide | 0.5 |
| | cyclohexane | | | |
| A3 | Isophorone diisocyanate | 1 | Phthalimide | 0.5 |
| A4 | Hexyl isocyanate | 0.1 | Phthalimide | 0.3 |
| A5 | Hexamethylene diisocyanate | 5 | Phthalimide | 0.5 |
| A6 | Isophorone diisocyanate | 5 | Phthalimide | 0.1 |
| A7 | Hexamethylene diisocyanate | 1 | Dimethyl phthalate | 0.5 |
| A8 | 1,3-bis(isocyanatomethyl) | 3 | Dimethyl phthalate | 0.5 |
| | cyclohexane | | | |
| B1 | Hexamethylene diisocyanate | 1 | — | 0 |
| B2 | — | 0 | — | 0 |
| B3 | — | 0 | Phthalimide | 0.5 |
| B4 | — | 0 | Dimethyl phthalate | 0.5 |
| B5 | 1,3-bis(isocyanatomethyl) | 7 | Phthalimide | 0.5 |
| | cyclohexane | | | |

TABLE 2

| | |
|---|---|
| OCV(V) | IR(mΩ) |

| | | After high | | After high |
|---|---|---|---|---|
| | Initial | temperature | Initial | temperature |
| | period | storage | period | storage |
| A1 | 3.259 | 3.213 | 263 | 272 |
| A2 | 3.262 | 3.224 | 248 | 260 |
| A3 | 3.255 | 3.218 | 257 | 269 |
| A4 | 3.241 | 3.192 | 281 | 290 |
| A5 | 3.262 | 3.219 | 252 | 259 |
| A6 | 3.257 | 3.211 | 282 | 288 |
| A7 | 3.237 | 3.191 | 292 | 307 |
| A8 | 3.242 | 3.201 | 290 | 300 |
| B1 | 3.222 | 3.108 | 362 | 571 |
| B2 | 3.249 | 3.160 | 369 | 543 |
| B3 | 3.144 | 3.110 | 297 | 320 |
| B4 | 3.138 | 3.121 | 310 | 342 |
| B5 | 3.232 | 3.185 | 322 | 359 |

In the batteries A1 to A8, in which the non-aqueous electrolyte included the first component and the second component, and the first component concentration was 5 mass % or less, compared with the batteries B1 to B5, the initial OCV was high and the internal resistance was low. Also, in the batteries A1 to A8, compared with the batteries B1 to B5, the reduction in the OCV after storage at a high temperature was small, and the increase in the IR was greatly reduced.

In the battery B5, in which the non-aqueous electrolyte included the first component and the second component, but the first component concentration was more than 5 mass %, the OCV in the initial period and after storage at a high temperature was relatively good, but the initial IR and the IR after storage at a high temperature increased greatly. This is probably because the first component was excessive.

In the battery B1, in which the non-aqueous electrolyte did not include the second component but included the first component, the OCV after storage at a high temperature reduced greatly, and the IR increased significantly. Also, the evaluation results for the battery B1 were even worse than the battery B2, in which the first component and the second component were not used. The results show that with the first component alone, the effects of keeping the OCV and IR after storage at a high temperature to a good level cannot be brought out, and synergy was brought out when used with the second component.

In the batteries B3 and B4 in which the non-aqueous electrolyte did not include the first component but included the second component, tendencies to reduce the IR were seen, but not sufficient. In the batteries B3 and B4, the initial OCV was low. The results show that with the second component alone, it is difficult to obtain a lithium primary battery that exhibits a high OCV and a low IR in any of the initial period and after storage at a high temperature.

### INDUSTRIAL APPLICABILITY

The lithium primary battery of the present disclosure is suitably used, for example, for a main power source for various meters, and a power source for a memory backup. However, use of the lithium primary battery is not limited to these.

### REFERENCE SIGNS LIST

1 positive electrode
1a positive electrode current collector
2 negative electrode
3 separator
4 positive electrode lead
5 negative electrode lead
6 upper insulating plate
7 lower insulating plate
8 sealing plate
9 battery case
10 lithium primary battery

1. A lithium primary battery comprising: a positive electrode, a negative electrode, and a non-aqueous electrolyte, wherein,
the positive electrode includes a positive electrode mixture including manganese dioxide,
the negative electrode includes at least one of a metal lithium and a lithium alloy,
the non-aqueous electrolyte includes an isocyanate compound as a first component, and at least one of a cyclic imide compound and a phthalic acid ester compound as a second component, and
the non-aqueous electrolyte has an isocyanate compound concentration of 5 mass % or less.

2. The lithium primary battery of claim 1, wherein a mass ratio of the first component relative to the second component included in the non-aqueous electrolyte is 1/3 or more and 50 or less.

3. The lithium primary battery of claim 1, wherein the isocyanate compound has at least one isocyanate group, and a C1 to C20 aliphatic hydrocarbon group or a C6 to C20 aromatic hydrocarbon group.

4. The lithium primary battery of claim 1, wherein the isocyanate compound includes at least one selected from the group consisting of hexyl isocyanate, hexamethylene diisocyanate, 1,3-bis(isocyanatomethyl)cyclohexane, and isophorone diisocyanate.

5. The lithium primary battery of claim 1, wherein the cyclic imide compound includes at least one selected from the group consisting of phthalimide and N-substituted phthalimide.

6. The lithium primary battery of claim 5, wherein the cyclic imide compound includes at least phthalimide.

7. The lithium primary battery of claim 1, wherein the phthalic acid ester compound includes dimethyl phthalate.

8. A non-aqueous electrolyte used for a lithium primary battery, the lithium primary battery comprising a positive electrode including a positive electrode mixture including manganese dioxide, a negative electrode including at least one of a metal lithium and a lithium alloy, and a non-aqueous electrolyte, wherein
the non-aqueous electrolyte includes an isocyanate compound as a first component, at least one of a cyclic imide compound and a phthalic acid ester compound as a second component, and
the non-aqueous electrolyte has an isocyanate compound concentration of 5 mass % or less.
